(19) United States
(12) Patent Application Publication
(10) Pub. No.: US 2013/0219695 A1
(43) Pub. Date: Aug. 29, 2013

(54) SURFACE MOUNTER FOR MOUNTING LED AND METHOD USING THE SAME

(71) Applicant: CHIH-CHEN LAI, New Taipei (TW)

(72) Inventor: CHIH-CHEN LAI, New Taipei (TW)

(21) Appl. No.: 13/681,430

(22) Filed: Nov. 20, 2012

(30) Foreign Application Priority Data
Feb. 23, 2012 (TW) 101105947

(51) Int. Cl. F21K 99/00

(52) U.S. Cl. CPC F21K 9/30; F21K 9/90
USPC 29/592.1; 29/739

(57) ABSTRACT

A method for mounting an LED (light emitting diode) on a substrate, includes following steps. Firstly a substrate and an LED are provided. Secondly a surface mounter is provided, which includes a nozzle and a sensor in the nozzle. The nozzle includes a first electrode and a second electrode. Thirdly the nozzle is used to pick up the LED. The LED electrically connects with the first electrode and the second electrode of the nozzle to emit light towards the sensor, and the sensor detects optical characteristics of the light. Fourthly it is decided whether to mount the LED on the substrate or not according to the optical characteristics of the light detected by the sensor. An LED surface mounter which includes a vacuum nozzle and an optical sensor in the vacuum nozzle is also provided.

### TECHNICAL FIELD

The present disclosure relates to a surface mounter and a method using the surface mounter, and more particularly, to a surface mounter for mounting LEDs and a method using the surface mounter, wherein the surface mounter is a vacuum pickup with an optical detecting device for detecting optical characteristics of the LED picked up by the surface mounter.

### DESCRIPTION OF RELATED ART

LEDs (Light-Emitting Diode) have many advantages, such as high luminosity, low operational voltage, low power consumption, compatibility with integrated circuits, easy driving, long term reliability, and environmental friendliness. Such advantages have promoted the wide use of LEDs as a light source. Nowadays, LED lamps are commonly applied in general lighting. Generally, the LED lamp includes light bars arranged in particular patterns for producing a desired illumination. LEDs are mounted on a long-strip substrate by a surface mounter to form the LED light bar. The surface mounter often includes a vacuum nozzle for drawing LEDs from a chassis and then mounting the LEDs to the substrate. After mounting the LEDs on the substrate, a detector is provided to detect optical characteristics of the LEDs. However, separation of the mounting step and the detecting step is labor-intensive and time-consuming. Furthermore, the LEDs need to be removed from the substrate if undesired optical characteristics thereof being detected. This will lead the manufacturing process of the light bar to be more complex.

What is needed, therefore, is a surface mounter and a mounting method thereof, which can overcome the disadvantages of the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is schematic of a surface mounter in accordance with an embodiment of the present disclosure.

FIG. 2 is a top view of the surface mounter of FIG. 1.

FIG. 3 shows a first step of a method for mounting an LED on a substrate by using the surface mounter of FIG. 1.

FIG. 4 shows a second step of the method for mounting an LED on a substrate following the step of FIG. 3.

### DETAILED DESCRIPTION

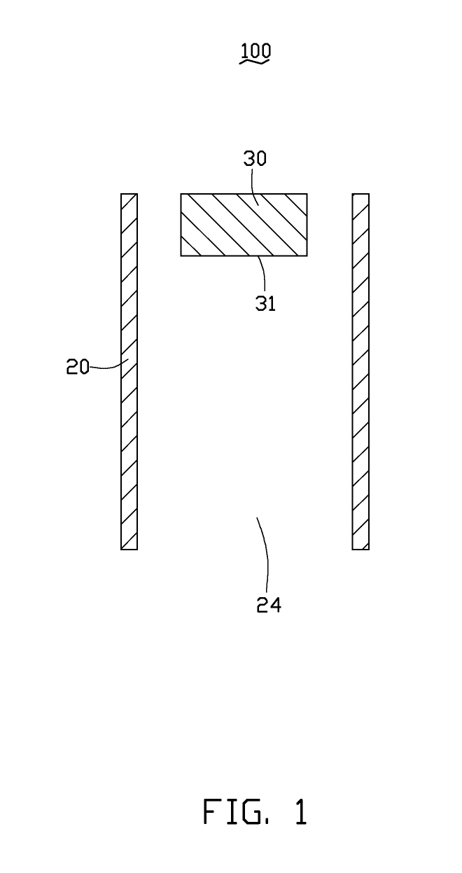

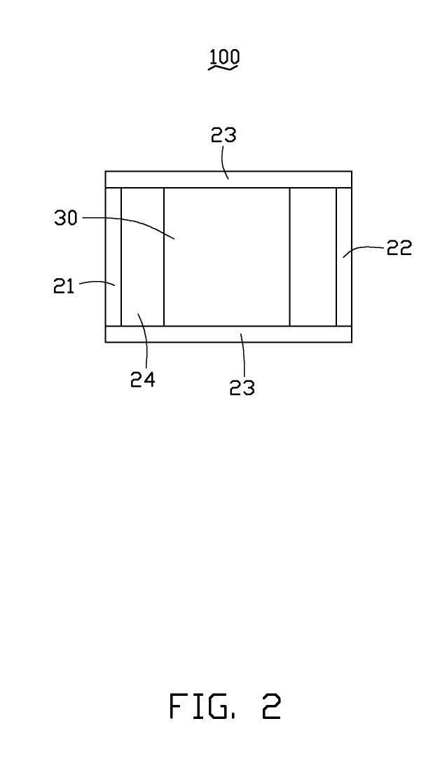

Referring to FIGS. 1-2, a surface mounter 100 in accordance with an embodiment of the present disclosure is shown. The surface mounter 100 which can also be termed as a vacuum pickup includes a nozzle 20 and a sensor 30. From a top view shown in FIG. 2, the nozzle 20 exhibits a rectangular profile. From a bottom view, the nozzle 20 also exhibits a rectangular profile. The nozzle 20 includes a first electrode 21, a second electrode 22 and two electrically insulating portions 23. The first electrode 21 and the second electrode 22 locate in two opposite ends of the box-shaped structure. The two electrically insulating portions 23 locate at other two opposite ends of the box-shaped structure and connect the first electrode 21 and the second electrode 22. The first and second electrodes 21, 22 are made of copper plated with gold. A vacuum portion 24 is formed in a middle of the nozzle 20. The vacuum portion 24 is surrounded by the first electrode 21, the second electrode 22 and the two electrically insulating portions 23. In an alternative embodiment, the nozzle 20 is an integrally molded cylinder made of electrically insulating material, such as plastic. Then, two separated conductive sheets, such as metal sheets, functioning as the first electrode 21 and the second electrode 22, are secured at two opposite inner sides of the cylinder. The vacuum portion 24 is connected to a vacuum source such as a vacuum pump to suck an LED 40 to be mounted to a bottom end of the nozzle 20 by vacuum suction.

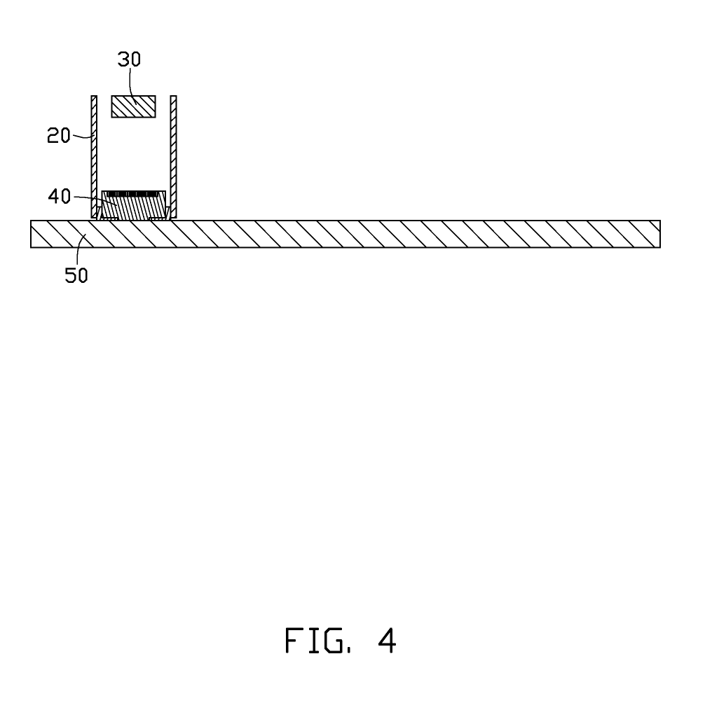

The sensor 30 connects to a top end of the nozzle 20. The sensor 30 is set on top of the vacuum portion 24 and between the first electrode 21, the second electrode 22 and the electrically insulating portions 23. The sensor 30 is physically connected to the insulating portions 23, and electrically connected to the first electrode 21 and the second electrode 22 by wires or other devices such as flexible printed circuit (FPC). The sensor 30 includes a detecting surface 31 facing the vacuum portion 24. The sensor 30 detects light generated by the LED 40 and emitting to the detecting surface 31, and then sends optical signals representing the optical characteristics (such as brightness, color temperature, light field distribution) of the light to a data processing device (not shown). The data processing device analyzes the optical characteristics and determines whether the LED 40 is qualified. If the LED 40 is qualified, the data processing device sends a signal to make the nozzle 20 to put the LED 40 on a substrate 50 (see FIG. 4). If the LED 40 is disqualified, the data processing device sends another signal to make the nozzle 20 to throw the LED 40 in a container (not shown) to be repaired, thrown away, or disposed by other ways. If necessary, the sensor 30 can also be connected to a spectrometer for wavelength analysis via an optical fiber.

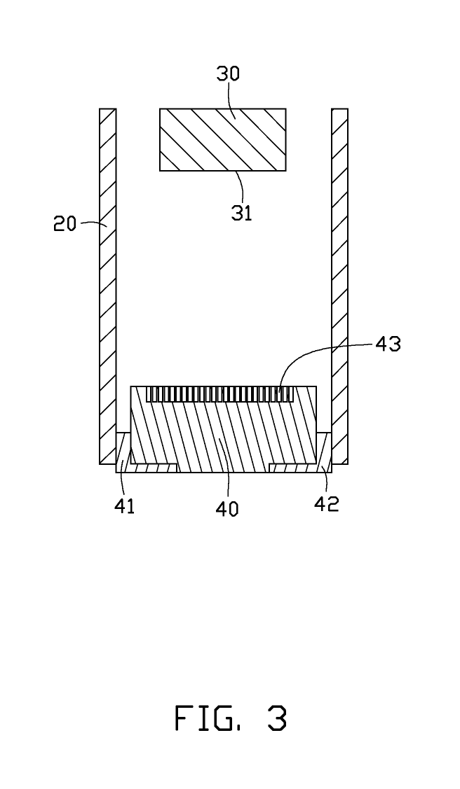

Referring to FIGS. 3-4, a method using the surface mounter 100 for mounting the LED 40 on the substrate 50, is shown. The mounting method includes two steps. Firstly, the nozzle 20 picks up the LED 40 by vacuum suction. The LED 40 includes two electrodes 41, 42 located on a bottom end thereof. The LED 40 also includes an emitting surface 43 on a top end thereof from which light emits upwardly. When the LED 40 is sucked by the nozzle 20, the two electrodes 41, 42 of the LED 40 are in contact with the first electrode 21 and the second electrode 22 of the nozzle 20, respectively, and the emitting surface 43 of the LED faces the detecting surface 31 of the sensor 30. The LED 40 is powered through the first electrode 21 and the second electrode 22 of the nozzle 20 to emit light. The light emitted by the LED 40 enters the detecting surface 31. The sensor 30 detects the optical characteristics of the LED 40 and transfers the data of the optical characteristics to the data processing device. The data processing device determines whether the LED 40 is qualified according to the optical characteristics of the LED 40, and then controls the nozzle 20 to mount the LED 40 to the substrate 50 or throw the LED 40 to the container. Alternatively, the data processing device can display the detected optical characteristics of the LED 40 on a display device (not shown). According to the tested data shown on the display device, an operator can decide whether the LED 40 is qualified, and then control the nozzle 20 to mount the LED 40 to the substrate 50 or throw the LED 40 to the container.

Secondly, the qualified LED 40 is put on the substrate 50 (shown in FIG. 4) by the nozzle 20 to complete mounting of the LED 40. The above steps are repeated until required qualified LEDs 40 are totally mounted on the substrate 50.

Because the mounter 100 includes a sensor 30 mounted in the nozzle 20, the LED 40 can be detected by the sensor 30 at the same time when picked up by the nozzle 20. Thus, the manufacturing steps of the light bars are reduced. Accordingly, the manufacture of the light bars is time-saving and labor-saving, thereby having a low manufacturing cost.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A surface mounter for an LED (light emitting diode), comprising:
a nozzle comprising a first electrode and a second electrode; and
a sensor comprising a detecting surface;
wherein when the nozzle picks up an LED by a vacuum suction, the LED being in contact with the first electrode and the second electrode of the nozzle to emit light towards the detecting surface of the sensor, and the sensor receiving and detecting the light from the LED.

2. The surface mounter of claim 1, wherein the nozzle further comprises two electrically insulating portions, and the first electrode and the second electrode of the nozzle are set apart by the two electrically insulating portions.

3. The surface mounter of claim 2, wherein the first electrode, the second electrode and the two electrically insulating portions surround the sensor.

4. The surface mounter of claim 1, wherein the nozzle comprises a top end and a bottom end, the sensor is set at the top end of the nozzle and the LED is picked up by the vacuum suction to be located at the bottom end of the nozzle.

5. The surface mounter of claim 1, wherein the nozzle comprises an integrally molded cylinder made of electrically insulating material, two separated conductive sheets being attached on two opposite inner sides of the cylinder to function as the first electrode and the second electrode, respectively.

6. The surface mounter of claim 1, wherein the first electrode and the second electrode are made of copper plated with gold.

7. The surface mounter of claim 1, wherein the nozzle has a rectangular profile as viewed from a bottom end thereof.

8. A method for mounting an LED (light emitting diode) on a substrate, comprising:
providing a substrate;
providing an LED;
providing a surface mounter comprising a nozzle and a sensor incorporated in the nozzle, the nozzle comprising a first electrode and a second electrode;
controlling the nozzle to pick up the LED by vacuum force, the LED contacting the first electrode and the second electrode of the nozzle to emit light towards the sensor, and the sensor detecting optical characteristics of the light; and
determining whether to mount the LED on the substrate according to the optical characteristics of the light detected by the sensor.

9. The method of claim 8, wherein the nozzle further comprises two electrically insulating portions, and the first electrode and the second electrode of the nozzle are set apart by the two insulating portions.

10. The method of claim 9, wherein the first electrode, the second electrode and the two electrically insulating portions surround the sensor.

11. The method of claim 8, wherein the nozzle comprises a top end and a bottom end, the sensor is set at the top end of the nozzle and the LED is picked up by the bottom end of the nozzle.

12. The method of claim 8, wherein the nozzle is an integrally molded cylinder made of electrically insulating material, two separated conductive sheets being attached at two opposite sides of an inner face of the cylinder to function as the first electrode and the second electrode.

13. The method of claim 8, wherein the first electrode and the second electrode each are made of a copper plate.
